(19) United States
(12) Patent Application Publication
(10) Pub. No.: US 2001/0035736 A1
(43) Pub. Date: Nov. 1, 2001

(54) Tool storage apparatus

(76) Inventor: Jack Person, Vacaville, CA (US)

Correspondence Address: Matthew J. Peirce, Esq., 1550 Starlight Canyon Avenue, Las Vegas, NV, 89123, US

(21) Appl. No.: 09/828,373

(22) Filed: Apr. 5, 2001

Related U.S. Application Data
(60) Provisional application No. 60/195,125, filed on Apr. 6, 2000.

(51) Int. Cl. H02J 7/00

(52) U.S. Cl. 320/114

(57) ABSTRACT

A storage apparatus for use with an electric tool giving a user easier use of the tool is disclosed. The present invention would comprise a pouch, which include separate pockets for a drill and a battery pack. The present invention would also comprise a drill that would be attached to a battery pack via a recoilable power cord. The pouch of the present invention would attach to a belt that would be worn by a user while using the present invention.

### BACKGROUND OF THE INVENTION

The present invention is that of a new and improved apparatus allowing for easier use of a battery-operated drill.

### II. DESCRIPTION OF THE PRIOR ART

U.S. Pat. No. 4,748,344, issued to Sing, discloses a portable power supply carrier which comprises an internally wired belt to be worn around a user's waist, the belt having pairs of electrical connectors spaced along its length for operatively engaging a plurality of battery holders which are removably supported on the belt.

U.S. Pat. No. 3,999,110, issued to Ramstrom et al., discloses a securing means particularly for slide-in type battery pack to be used in cordless electric power tools.

U.S. Pat. No. 3,919,615, issued to Niecke, discloses a power belt which comprise a belt member adapted to be secured around the waist of a person using the belt, and a plurality of pockets carried up the belt member.

### III. SUMMARY OF THE INVENTION

The present invention is that of a storage apparatus for use with an electric tool giving a user easier use of the tool. The present invention would comprise a pouch, which include separate pockets for a drill and a battery pack. The present invention would also comprise a drill that would be attached to a battery pack via a recoilable power cord. The pouch of the present invention would attach to a belt that would be worn by a user while using the present invention.

The present invention is designed to be easy to use, be powerful, and last a long time. The present invention would be most useful for homeowners, craft workers, construction workers, and military personnel.

There has thus been outlined, rather broadly, the more important features of a storage apparatus for use with an electric tool in order that the detailed description thereof that follows may be better understood and in order that the present contribution to the art may be better appreciated. There are, of course, additional features of the storage apparatus for use with an electric tool that will be described hereinafter and which will form the subject matter of the claims appended hereto.

In this respect, before explaining at least one embodiment of the storage apparatus for use with an electric tool in detail, it is to be understood that the storage apparatus for use with an electric tool is not limited in its application to the details of construction and to the arrangements of the components set forth in the following description or illustrated in the drawings. The storage apparatus for use with an electric tool is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present storage apparatus for use with an electric tool. It is important, therefore, that the claims be regard as including such equivalent constructions insofar as they do not depart from the spirit and scope of the present invention.

It is therefore an object of the present invention to provide a storage apparatus for use with an electric tool which has all of the advantages of the prior art and none of the disadvantages.

It is another object of the present invention to provide a storage apparatus for use with an electric tool which may be easily and efficiently manufactured and marketed.

It is another object of the present invention to provide a storage apparatus for use with an electric tool which is of durable and reliable construction.

It is yet another object of the present invention to provide a storage apparatus for use with an electric tool which is economically affordable and available for the public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front perspective view of the pouch of the present invention.

FIG. 2 shows a front perspective view of the drill and attached battery pack of the present invention.

FIG. 3 shows a front perspective view of a belt that is associated with the pouch of the present invention.

FIG. 4 shows a front perspective view of the drill and attached battery pack of the present invention associated with the belt that would be used in conjunction with the present invention.

### V. DESCRIPTION OF THE PREFERRED EMBODIMENT

Referring now to FIG. 1, a front perspective view of pouch 2 of the present invention is shown. Pouch 2 can be seen drill pouch 4 and battery pack pouch 6 front-mounted on pouch 2. Drill pouch 4 and battery pack pouch 6 are separate pockets designed to contain a drill and a battery pack, respectively, when they would be placed within the appropriate pockets. Pouch 2 can be seen as it is attached belt 8, which would be worn by a user of the present invention around their waist. Pouch 2 is designed as an optional item to buy for aiding a user with having an adequate place to put drill 10 of the present invention when not in use.

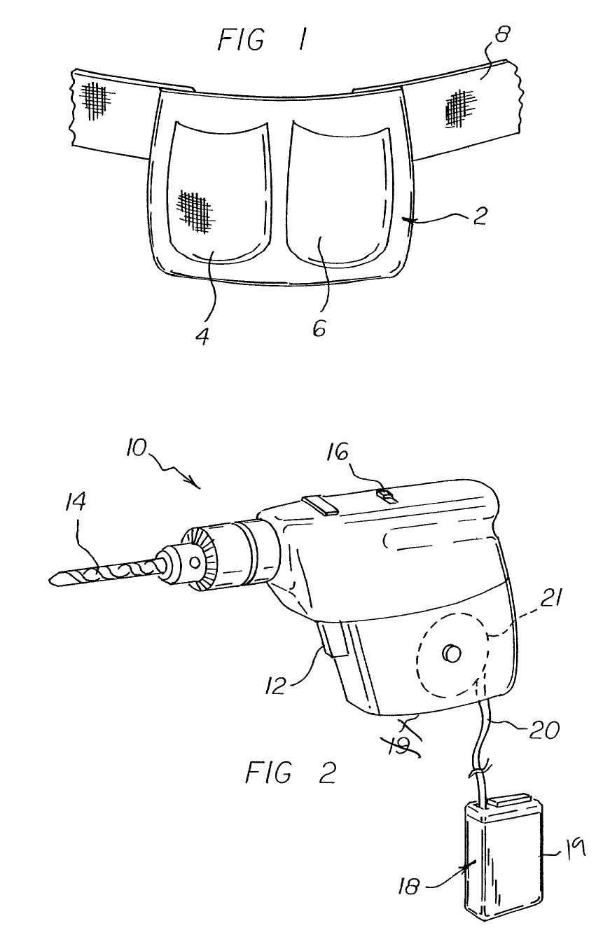

FIG. 2 shows a front perspective view of drill 10 and attached battery pack 18 of the present invention. Drill 10 includes power button 12, which would be used to activate power in drill 10. Drill 10 also includes drill bit 14, seen attached, which would be used by a user for drilling a hole. Drill 10 also includes top-mounted forward/reverse button 16, which controls whether drill bit 14 would rotate clockwise or counterclockwise.

Battery pack 18 would be attached to drill 10 via recoilable power cord 20, which would be an electrical connection. Battery pack 18 would include an internal battery 19, while spool 21 would be located within the handle portion of drill 10. Battery 19 would provide power to drill 10 via recoilable power cord 20, while spool 21 would allow any unused length of recoilable power cord 20 to be pulled around spool 21 and appropriately stored while not in use. This feature would ensure that extra lengths of recoilable power cord 20 would not cause injury or otherwise present a hazard for a person while using the present invention. While the present invention would be in use, battery pack 18 would preferably be placed within battery pack pouch 6 of pouch 2 of the present invention.

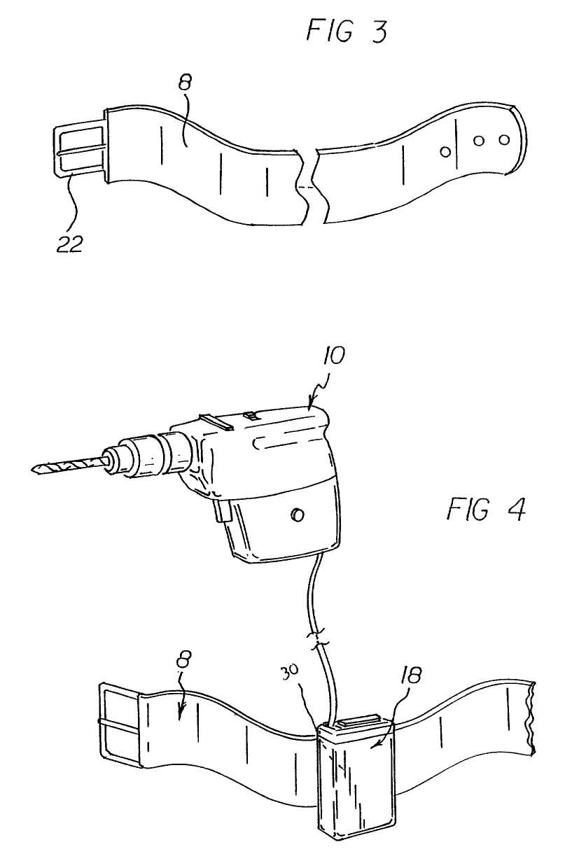

FIG. 3 shows a front perspective view of belt 8 that is associated with the pouch 2 of the present invention. A user would wear belt 8 while using the present invention. Belt 8 would also include some type of buckle 22 mounted on one end of belt 8. Belt 8 is designed as an optional item to buy for aiding a user with having an adequate place to put drill 10 of the present invention when not in use.

FIG. 4 shows a front perspective view of drill 10 and attached battery pack 18 of the present invention as associated with belt 8, which would be used in conjunction with the present invention. Battery pack 18 would be designed to have a rear-mounted belt clip 30 which would allow battery pack 18 to attach to belt 8. This figure shows how the present invention would appear in use.

The concept of the present invention can not only be used for drill 10, but could also be used for reciprocating saws, circular saws, flashlights, and any of today's battery associated power tools.

What I claim as my invention is:

1. A storage apparatus for use with an electric tool comprising:
a. a belt having two ends, a first end and a second end,
b. a buckle attached to the first end of the belt,
c. a pouch removably attached to the belt, the pouch having a front side and a rear side,
d. a first pocket attached to the front side of the pouch, the first pocket designed for storage of the electric tool,
e. a second pocket attached to the front side of the pouch, the second pocket designed for storage of power means for the electric tool, and
f. a battery holder, the battery holder having a front side and a back side, the battery holder being removably attached to the belt.

2. The storage apparatus for use with an electric tool according to claim 1 wherein the electric tool would be an electric drill.

3. The storage apparatus for use with an electric tool according to claim 2 in combination with:
(a) an electric drill, the electric drill including an internal spool, the spool being rotatably mounted within the handle of the electric drill,
(b) power means for providing power to the electric drill, the power means preferably being a rechargeable battery located within the battery holder, and
(c) a cord having two ends, a first end and a second end, the cord generally being wound around the spool when not in use, the first end of the cord being connected to the electric drill, the second end of the cord being connected to the power means.
